(19) United States
(12) Patent Application Publication
(10) Pub. No.: US 2023/0389536 A1
(43) Pub. Date: Dec. 7, 2023

(54) MOTION DETECTING RODENT TRAY

(71) Applicant: Michael Joseph Schneider, Cape Coral, FL (US)

(72) Inventor: Michael Joseph Schneider, Cape Coral, FL (US)

(21) Appl. No.: 18/327,205

(22) Filed: Jun. 1, 2023

Related U.S. Application Data
(60) Provisional application No. 63/473,502, filed on Jun. 6, 2022.

(51) Int. Cl. A01M 23/24; G08B 21/18; H04Q 9/00

(52) U.S. Cl. CPC A01M 23/245; G08B 21/18; H04Q 9/00; H04Q 2209/88

(57) ABSTRACT

A device for receiving a rodent trap includes a first planar portion for receiving the trap and a second planar portion operably connected to and extending from the first planar portion. The device also includes electronic components configured to be housed within one or more of the first planar portion or the second planar portion. The electronic components include a sensor configured to detect motion of an object located on one or more of the first planar portion or the second planar portion, a battery configured to provide power to the device; and a communications system configured to provide data from the sensor to a computing device.

### CROSS REFERENCE TO RELATED APPLICATIONS

The present application claims the benefit of U.S. Provisional Patent Application No. 63/473,502 filed Jun. 6, 2022, entitled “Motion detecting rodent trap tray,” the entire disclosure of which is hereby incorporated herein by reference for all purposes.

### BACKGROUND OF THE INVENTION

Typical rodent traps are placed directly on the floor or other surfaces where rodents may be active. However, in large buildings numerous traps may be used such that a user will have to physically check each trap to determine whether the trap was activated and/or a rodent was trapped. Additionally, traps are often contaminated by the blood and fragments of the flesh of a rodent killed by trap which may spill into the floor or other surface where the trap is laid. As such, an improved system is desired which can notify a user if a trap has been activated and will prevent undesired contaminates from reaching the floor.

### BRIEF SUMMARY OF THE INVENTION

In one example, a device for holding a rodent trap includes a first portion for receiving the trap and a second portion operably connected to and extending from the first portion. The device also includes electronic components configured to be housed within at least one of the first planar portion and the second portion. The electronic components include a sensor configured to detect motion of an object located on one or more of the first portion or the second portion, an electrical power source configured to provide power to the device, and a communications system configured to provide data from the sensor to a computing device.

In another example, a system for notifying a user of rodent activity includes a first planar portion, a second planar portion extending from the first planar portion at an angle of approximately 30-140 degrees. The system also includes a rodent trap disposed on the first planar portion and electronic components configured to be housed within one or more of the first planar portion or the second planar portion. The electronic components include a sensor configured to detect motion of an object located on one or more of the first planar portion or the second planar portion, an electrical power source configured to provide power to the device; and a communications system configured to provide data from the sensor to a computing device.

In another example, a method for using the device includes receiving data from the sensor, and determining, by a machine learning algorithm, whether the data indicates movement of an object in an area around the first planar portion or the second planar portion. The method also includes sending the data from the communications system to a user device upon determining that the data indicates movement of the object. Additionally, the method includes displaying a location of the sensor where movement of the object has been indicated.

In some examples, the first planar portion includes a first side wall disposed opposite a second side wall, and a third side wall disposed opposite a fourth side wall with the third and fourth sidewalls coupling the first and second side walls.

In some examples, the first planar portion includes a nonporous top surface.

In some examples, the electrical power source is a battery.

In some examples, the first planar portion defines a recess on a bottom surface to house the battery.

In some examples, the second planar portion extends at an angle from one of the first, second, third, or fourth sidewalls of the first planar portion, with the angle being approximately 10-160 degrees.

In some examples, the angle is approximately 30-140 degrees.

In some examples, the angle is approximately 60-120 degrees.

In some examples, the angle is approximately 80-100 degrees.

In some examples, the second planar portion defines a recess to house the sensor.

In some examples, the sensor is one or more of a motion sensor, a camera, or a piezoelectric element.

In some examples, the battery is rechargeable.

In some examples, the first planar portion has a thickness of less than one inch.

### BRIEF DESCRIPTION OF THE SEVERAL VIEWS OF THE DRAWINGS

The foregoing summary, as well as the following detailed description of the present disclosure, will be better understood when read in conjunction with the appended drawings. For the purpose of illustrating the present disclosure, there are shown in the drawings examples which are presently preferred. It should be understood, however, that the present disclosure is not limited to the precise arrangements and instrumentalities shown.

In the Drawings:

FIG. 1 is a perspective view of a device for receiving a rodent trap and a rodent trap disposed thereon in accordance with an exemplary embodiment of the subject disclosure;

FIG. 2 is a side view of the device for receiving the rodent trap of FIG. 1 with the rodent trap removed;

FIG. 3 is a top view of the device for receiving the rodent trap of FIG. 1 with the rodent trap removed;

FIG. 4 is a bottom view of the device for receiving the rodent trap of FIG. 1; and

FIG. 5 is a schematic view of the device including a communications system thereof.

### DETAILED DESCRIPTION OF THE INVENTION

Reference will now be made in detail to the present examples of the present disclosure illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. The term “distal” shall mean away from the center of a body. The term “proximal” shall mean closer towards the center of a body and/or away from the “distal” end. Such directional terms used in conjunction with the following description of the drawings should not be construed to limit the scope of the present disclosure in any manner not explicitly set forth.

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the identified element and designated parts thereof. Additionally, the term “a,” as used in the specification, means “at least one.” The terminology includes the words noted above, derivatives thereof and words of similar import.

“About” as used herein when referring to a measurable value such as an amount, a temporal duration, and the like, is meant to encompass variations of ±20%, ±10%, ±5%, ±1%, and ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the present disclosure can be presented in a range format.

It should be understood that the description in range format is merely for convenience and brevity and should not be construed as an inflexible limitation on the scope of the present disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the examples of the present disclosure may be combined in any suitable manner in one or more examples. One skilled in the relevant art will recognize, in light of the description herein, that the present disclosure can be practiced without one or more of the specific features or advantages of a particular exemplary example. In other instances, additional features and advantages may be recognized in certain examples that may not be present in all examples of the present disclosure.

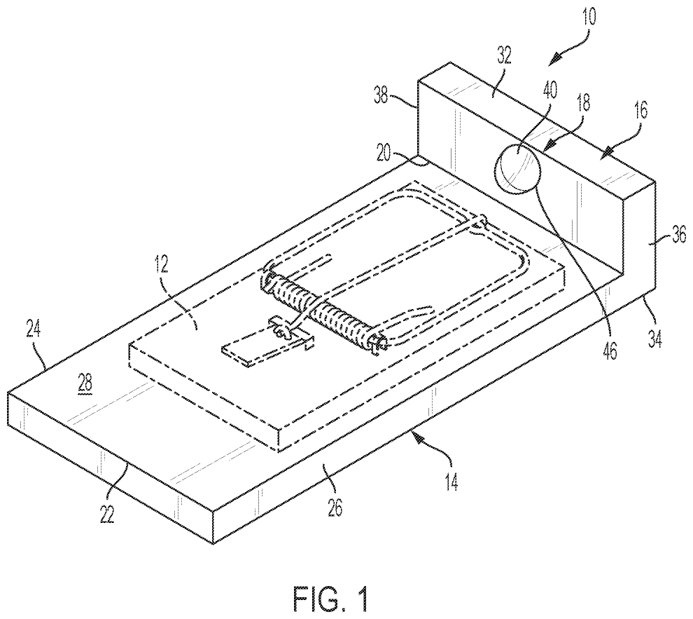

Referring to the figures, FIG. 1 shows an example a device 10 that receives or holds a trap 12 for capturing a pest, such as a rodent. With the device 10, many types of traps 12 may be placed on the device 10, and a user may easily detect the setting off of the traps 12 and know which traps 12 need to be inspected.

The device 10 includes a first planar portion 14, a second planar portion 16, and electronic components generally indicated by reference numeral 18 configured to be housed within at least one of the first planar portion 14 and the second planar portion 16.

The first planar portion 14 has a generally flat area for receiving or holding a trap 12 that captures a pest, such as a rodent. In some examples the generally flat area may be disposed on a top surface 30 of the first planar portion 14, however, it is contemplated that the area for holding the trap 12 may encompass more than just the first planar portion 14, if desired.

Referring still to the example shown in FIG. 1, the first planar portion 14 also includes a first sidewall 20 disposed opposite a second sidewall 22. In the example shown, the first and second sidewalls 20, 22 are generally straight and disposed parallel to one another. However, various other configurations have been contemplated including but not limited to the first and second sidewalls 20, 22 extending at an angle with respect to one another, and/or one or more of the first and second sidewalls 20, 22 may include one or more projections or indentations. Additionally, the first planar portion 14 includes a third sidewall 24 disposed opposite a fourth sidewall 26. Moreover, in the example shown, the third and fourth sidewalls 24, 26 extend between the first and second sidewalls 20, 22. However, it is also contemplated that one or more additional sidewalls may extend between the first and second sidewalls, if desired. Additionally, in the example shown the third and fourth sidewalls 24, 26 are generally straight and disposed parallel to one another. However, various other configurations have been contemplated including but not limited to the third and fourth sidewalls 24, 26 extending at an angle with respect to one another, and/or one or more of the third and fourth sidewalls 24, 26 may include one or more projections or indentations.

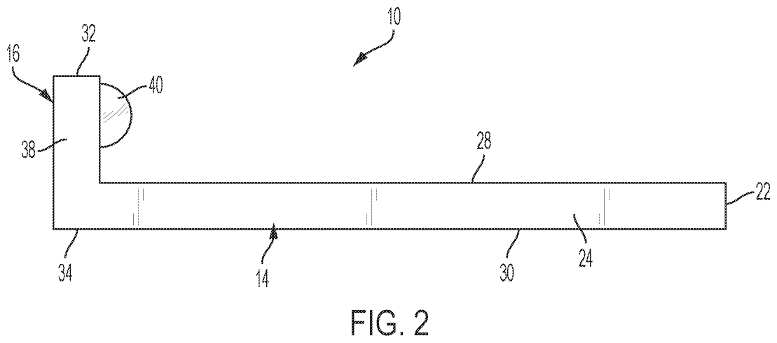

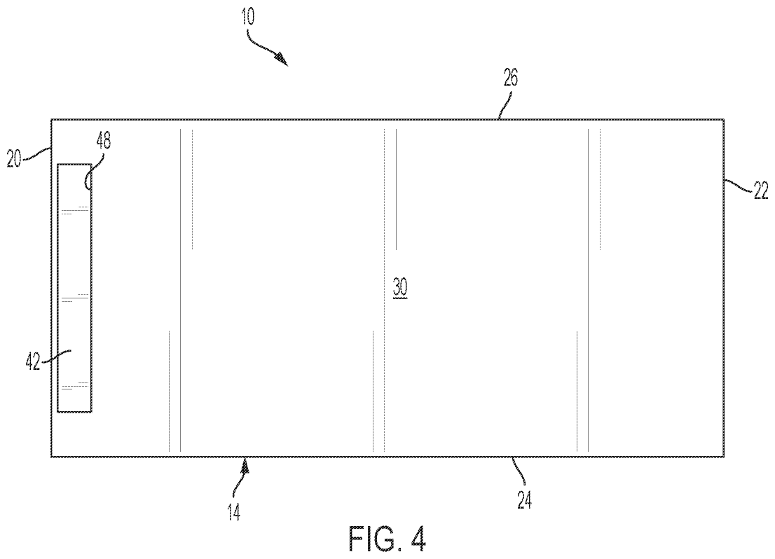

The first sidewall 20, the second sidewall 22, the third sidewall 24, and the fourth sidewall 26 define a top surface 28 and a bottom surface 30 (FIGS. 2 and 4) of the first planar portion 14. In the example shown, the entire top surface is generally flat, however, it is contemplated that the top surface 28 may include one or more grooves or recessed portions configured to secure or otherwise engage the rodent trap 12 and/or bait. Additionally, the bottom surface 30 may be generally flat or may include one or more recessed portions to house additional components and/or for packaging purposes.

In some examples the first planar portion 14 is comprised of a plastic polymer or other easily wipeable surface such that after use, the first planar portion 14 can simply be wiped or rinsed off and prepared for another use. In some examples, the first planar portion 14 may include a coating or other covering to provide the easily wipeable surface. Additionally, in the example shown, the first planar portion 14 has a thickness of approximately less than one inch. In other examples, the first planar portion 14 has a thickness of approximately less than one half inch. In other examples, the first planar portion 14 has a thickness of approximately less than one quarter inch. However, various other thicknesses have been contemplated.

The second planar portion 16 is operably connected to and extends from the first planar portion 14. In the example shown, the second planar portion 16 extends at an angle from the first sidewall 20, however, the second planar portion 16 may extend from one or more of the first, second, third, or fourth sidewalls 20, 22, 24, 26 of the first planar portion 14. The angle between the first planar portion 14 and the second planar portion 16 may be approximately 10-160 degrees between the first planar portion 14 and the second planar portion 16. In some examples, the angle between the first planar portion 14 and the second planar portion 16 may be approximately 30-140 degrees. In some examples, the angle between the first planar portion 14 and the second planar portion 16 may be approximately 60-120 degrees. In some examples, the angle between the first planar portion 14 and the second planar portion 16 may be approximately 80-100 degrees.

The second planar portion 16 may be similar to the first planar portion 14 in that the second planar portion 16 also includes a first sidewall 32 disposed opposite a second sidewall 34. In the example shown, the first and second sidewalls 32, 34 are generally straight and disposed parallel to one another. However, various other configurations have been contemplated including but not limited to the first and second sidewalls 32, 34 extending at an angle with respect to one another, and/or one or more of the first and second sidewalls 32, 34 may include one or more projections or indentations. Additionally, the second planar portion 16 includes a third sidewall 36 disposed opposite a fourth sidewall 38. Moreover, in the example shown, the third and fourth sidewalls 36, 38 extend between the first and second sidewalls 32, 34. However, it is also contemplated that one or more additional sidewalls may extend between the first and second sidewalls 32, 34, if desired. Additionally, in the example shown the third and fourth sidewalls 36, 38 are generally straight and disposed parallel to one another. However, various other configurations have been contemplated including but not limited to the third and fourth sidewalls 36, 38 extending at an angle with respect to one another, and/or one or more of the third and fourth sidewalls 36, 38 may include one or more projections or indentations.

Additionally, the second planar portion 16 may be similar to the first planar portion 14 in that is comprised of a plastic polymer or other easily wipeable surface such that after use, the second planar portion 16 can simply be wiped or rinsed off and prepared for another use. In some examples, the second planar portion 16 may include a coating or other covering to provide the easily wipeable surface. Additionally, in the example shown, the second planar portion 16 has a thickness of approximately less than two inches. In other examples, the second planar portion 16 has a thickness of approximately less than one inch. In other examples, the second planar portion 16 has a thickness of approximately less than one half inch. However, various other thicknesses have been contemplated.

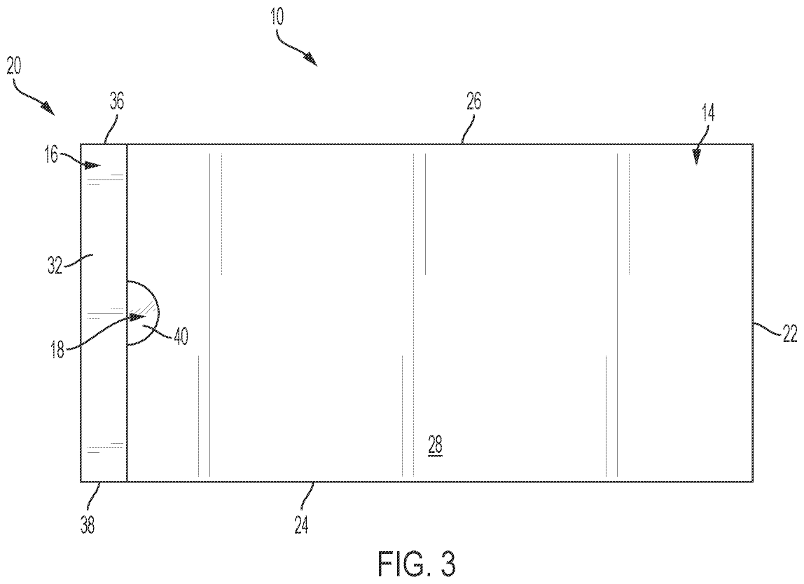

As best shown in FIG. 3, in some examples the second planar portion 16 is thicker than the first planar portion 14 such that the second planar portion 16 includes recesses or other features configured to house the electronic components 18, discussed in more detail below.

In some examples, the first planar portion 14 and the second planar portion 16 are manufactured as a single unitary piece. However, it is also contemplated that the first planar portion 14 and the second planar portion 16 may be manufactured separately and joined to one another thereafter. The first planar portion 14 and the second planar portion 16 may include temporary or fixed securing means to facilitate the securing of the first planar portion 14 and the second planar portion 16.

The electronic components 18 include a sensor 40, an electrical power source, such as an alternating current (AC) or direct current (DC) power source such as a battery 42, and a communications system 44. The sensor 40 is configured to detect motion of an object located on one or more of the first planar portion 14 or the second planar portion 16. In some examples, the sensor 40 may be one of a motion sensor, a camera, or a piezoelectric element. In other examples, the sensor 40 may be any type of sensor 40 including but not limited to a proximity sensor, an infrared sensor, a pressure sensor, a light detector or the like. In some examples, the sensor 40 is configured to detect motion or other mechanical disturbances which occur on the first planar portion 14 and/or the second planar portion 16.

In some examples, the second planar portion 16 defines a recess 46 which houses one or more elements of the communication device 10. In the example shown, the sensor 40 is disposed within a recess 46 in the second planar portion 16 and the recess 46 is shaped to direct the sensor 40 toward the first planar section. The recess 46 may be sized and shaped to fit the desired sensor 40. Additionally, the sensor 40 may be built in or otherwise secured to the second portion 16. In some examples, the sensor 40 may include a cover or other feature to allow the sensor 40 to remain easily wipeable similar to the first planar section and the second planar section.

In some examples, the second planar portion 16 has defines a second recess 48 which houses other element(s) of the communication device 10. In the example shown in FIG. 4, the battery 42 is disposed within the second recess 48 and is configured to provide power to the device 10. Additionally, the battery 42 may be any type of battery 42 including but not limited to a rechargeable battery, a lithium battery, an alkaline battery, a carbon zinc battery or the like. In some examples, the second recess 48 may be defined within the first planar portion 14 or defined in both the first planar portion 14 and the second planar portion 16. In the example shown, the second recess 48 is defined in the second planar portion 16 and near the sensor 40 to provide power to the device 10. However, various other configurations have been contemplated. Additionally, in the example shown the second recess 48 is generally rectangular, however, it is contemplated that the second recess 48 may be any shape and size to house the battery 42.

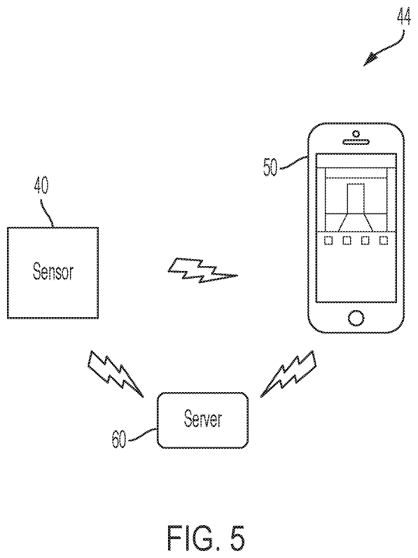

Referring now to FIG. 5, the communications system 44 is configured to provide data from the sensor 40 to a computing device 50. Computing devices 10 can include computers, laptops, tablets, mobile devices 10, Smartphones, cellular phones, and wireless devices 10 (e.g., cars with wireless communication). Example computing devices 10 include the iPhone, iPad, iMac, MacBook Air, and MacBook Pro made by Apple Inc. The means of communication can include the Internet, a wireless network, and/or a server 60. In some examples, the sensor 40 communicates with the remote computing device 50 without using a server. In some examples, the sensor 40 can send a wireless notification to the computing device 50 that is located remotely relative to the first planar portion 14 of the device 10.

In some examples, wireless communication can enable the sensor 40 to communicate with the computing device 50. Some examples enable communication via cellular and/or Wi-Fi networks. Some examples enable communication via the Internet. The wireless communication can include the following communication means: radio, Wi-Fi 33 (e.g., wireless local area network), cellular, Internet, Bluetooth, telecommunication, electromagnetic, infrared, light, Sonic, and microwave. Other communication means are used by some examples. In some examples, such as examples that include telecommunication or cellular communication means, the system can initiate voice calls or send text messages to the computing device 50 (e.g., a Smartphone, a desktop computer, a tablet computer, a laptop computer). It is also contemplated that wired communication can be effectuated between the sensor 40 and the computing device 50.

Some examples use near field communication (NFC) to communicate between the computing device 50 and the sensor 40. The device 10 and/or the computing device 50 can include an NFC tag. Some NFC technologies include Bluetooth, audio-frequency identification, and QR codes. Some examples include computer Software (e.g., application Software), which can be a mobile application designed to run on Smartphones, tablet computers, and other mobile devices 10. Software of this nature is sometimes referred to as “app” software. Some examples include software designed to run on desktop computers and laptop computers. The computing device 50 may run Software with a graphical user interface. The user interface can include icons or buttons. In some examples, the Software is configured for use with a touch-screen computing device 50 such as a Smart phone or tablet. The software may include a user interface displayed on a display screen. The user interface may include an indicator, which can indicate the location of the device 10 that the user interface is displaying. In some examples, the server 60 can initiate communication to the computing device 50 and/or to the sensor 40. In several examples, the server can initiate, control, and/or block communication between the computing device 50 and the sensor 40.

In several examples, a user can log into an “app”, website, and/or software on a computing device 50 (e.g., mobile computing device 50, Smartphone, tablet, desktop computer) to adjust the system settings discussed herein. In some examples, the computing device 50 can enable a user to watch live video and/or hear live audio from a sensor 40 due to the user's request rather than due to actions of detected movement. Some examples include a computing device 50 initiating a live video feed (or a video feed that is less than five minutes old). In some examples, the user interface displays an image such as a still image or a video of an area near and/or in front of the sensor 40. The image can be taken by the sensor 40 and stored by sensor 40, server and/or computing device 50. The user interface may include a recording button to enable a user to record images, videos, and/or sound from the sensor 40.

In some examples, the user interface includes a picture button to allow the user to take still pictures and/or videos of the area near and/or in front of the sensor 40. The user interface may also include a sound adjustment button and a mute button. The user interface can include manipulation buttons such as Zoom, pan, and light adjustment buttons. Some examples include an infrared camera and/or infrared lights to illuminate an area near the sensor 40 to provide sufficient visibility (even at night).

In some examples, the communication system can be configured to notify the remote computing device 50 regarding a presence of a motion event by sending an alert (e.g., a push notification) to the remote computing device 50. The alert 232 may be sent directly from the sensor 40 to the remote computing device 50. In some examples, the alert is sent directly and wirelessly. In some examples, the alert is sent via the server 60 and/or via the Internet. The alert may cause a push notification to appear on the user interface of the computing device 50. In some examples, the alert causes the remote computing device 50 to vibrate or “ring to notify the user of the remote computing device 50 that motion may be present near the sensor 40. The alert can include a video of the site where motion was detected.

In operation, a user places the device 10 in the desired location and then places a rodent trap 12 on the first planar portion 14 of the device 10. The device 10 and/or the rodent trap 12 may be secured to one another or to the desired location. In some examples, the user will place a plurality of devices 10 having a plurality of rodent traps 12 placed thereon throughout a space. When the sensor 40 of the device 10 senses that the rodent trap 12 has been activated or other motion has been detected near the rodent trap 12, the sensor 40 provides the motion data to the communications system. The communication system determines, by a machine learning algorithm, whether the data indicates movement of an object in an area around the first planar portion 14 or the second planar portion 16. The data is then sent from the communications system to the computing device 50 upon determining that the data indicates movement of the object. The location of the sensor 40 may then be displayed on the computing device 50 to assist the user in determining the location of the movement.

It will be appreciated by those skilled in the art that changes could be made to the examples described above without departing from the broad inventive concept thereof. For example, additional components and steps can be added to the various syringe cartridge systems. It is to be understood, therefore, that this present disclosure is not limited to the particular example disclosed, but it is intended to cover modifications within the spirit and scope of the present disclosure as defined by the appended claims.

We claim:

1. A device for holding a rodent trap, comprising:
a first portion for receiving the trap;
a second portion operably connected to and extending from the first portion; and
electronic components configured to be housed within at least one of the first planar portion and the second planar portion, the electronic components including:
a sensor configured to detect motion of an object located on one or more of the first planar portion or the second planar portion;
an electrical power source configured to provide power to the device; and
a communications system configured to provide data from the sensor to a computing device.

2. The device of claim 1, wherein the first portion includes a first side wall disposed opposite a second side wall, and a third side wall disposed opposite a fourth side wall with the third and fourth sidewalls extending between the first and second side walls.

3. The device of claim 1, wherein the second portion includes a first side wall disposed opposite a second side wall, and a third side wall disposed opposite a fourth side wall with the third and fourth sidewalls extending between the first and second side walls.

4. The device of claim 1, wherein the electrical power source is a battery.

5. The device of claim 4, wherein the first portion defines a recess on a bottom surface to house the battery.

6. The device of claim 2, wherein the second portion extends at an angle from one of the first, second, third, or fourth sidewalls of the first portion, with the angle being approximately 10-160 degrees.

7. The device of claim 6, wherein the angle is approximately 30-140 degrees.

8. The device of claim 6, wherein the angle is approximately 60-120 degrees.

9. The device of claim 6, wherein the angle is approximately 80-100 degrees.

10. The device of claim 1, wherein the second portion defines a recess to house the sensor.

11. The device of claim 1, wherein the sensor is one or more of a motion sensor, a camera, or a piezoelectric element.

12. The device of claim 4, wherein the battery is rechargeable.

13. The device of claim 1, wherein the first portion has a thickness of less than one inch.

14. A system for notifying a user of rodent activity, the system comprising:
a first planar portion;
a second planar portion extending from the first planar portion at an angle of approximately 30-140 degrees;
a rodent trap disposed on the first planar portion; and
electronic components configured to be housed within at least one of the first planar portion and the second planar portion, the electronic components including:
a sensor configured to detect motion of an object located on one or more of the first planar portion or the second planar portion;
an electrical power source configured to provide power to the device; and
a communications system configured to provide data from the sensor to a computing device.

15. The system of claim 14, wherein the angle is approximately 80-100 degrees.

16. The system of claim 14, wherein the electrical power source is a battery.

17. The system of claim 16, wherein the first planar portion defines a recess on a bottom surface to house the battery.

18. The system of claim 14, wherein the second planar portion defines a recess to house the sensor.

19. The system of claim 14, wherein the first planar portion has a thickness of less than one inch.

20. A method of using the device of claim 1, the method comprising:
receiving data from the sensor;
determining, by a machine learning algorithm, whether the data indicates movement of an object in an area around the first planar portion or the second planar portion;
sending the data from the communications system to a user device upon determining that the data indicates movement of the object; and
displaying a location of the sensor where movement of the object has been indicated.

21. The method of claim 20, further including the step of notifying the user to inspect the sensor.
